(19) United States
(12) Patent Application Publication
(10) Pub. No.: US 2006/0012922 A1
(43) Pub. Date: Jan. 19, 2006

(54) Magnetic sensor for encoder

(75) Inventor: Shigeru Shoji, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/157,858

(22) Filed: Jun. 22, 2005

(30) Foreign Application Priority Data
Jul. 14, 2004 (JP) 2004-207013

(51) Int. Cl. G11B 5/33; G11B 5/127

(52) U.S. Cl. 360/316

(57) ABSTRACT

A magnetic sensor for an encoder has a sliding surface and detects magnetic field by keeping the sliding surface in contact with a surface of a magnetic medium to which a magnetic pattern with a predetermined magnetization pitch is recorded. The magnetic sensor includes a plurality of MR elements laminated with each other in a direction parallel to a direction of the magnetization pitch of the magnetic medium. Between two of the MR elements an insulation layer is sandwiched. Each of the MR elements has a plurality of linear sections.

### PRIORITY CLAIM

This application claims priority from Japanese patent application No. 2004-207013, filed on Jul. 14, 2004, which is incorporated herein by reference.

### BACKGROUND OF THE INVENTION

1. Field of the Invention

The present invention relates to a magnetic sensor for an encoder, provided with a plurality of magnetoresistive effect (MR) elements.

2. Description of the Related Art

U.S. Pat. No. 4,594,548 and Japanese patent publication No. 10-160511A disclose typical magnetic encoders used for position detection, displacement detection or rotation detection. Each of these encoders has a magnetic medium with a certain magnetization pattern formed by the horizontal magnetization recording method, and a magnetic sensor with MR elements each having a sensing plane in parallel with the surface of the magnetic medium to sense a plane direction or horizontal direction component of the horizontally recorded magnetic field from the magnetic medium. Because the horizontal direction component of the horizontally recorded magnetic field is not so reduced even if the MR element is somewhat spaced from the magnetic medium and therefore it is easy to detect the magnetic field, detected is the horizontal direction component of this field.

In such typical magnetic encoders, a plurality of MR elements are arranged on the same plane to have a predetermined phase with each other in order to detect the moving direction of the object or to multiply the signal output.

However, it had become very difficult to arrange on the same plane many of MR elements each having a certain pattern width in order to satisfy a high resolution that is required for the encoder. If the pattern width of each MR element was reduced, the element sensitivity would drop.

In order to solve such problems of the prior art, Japanese patent publication No. 2002-206950A proposes a magnetic sensor cooperated with a small diameter magnetic drum, in which a plurality of MR films are laminated on a substrate with alternately sandwiching insulation films such that the surfaces of the respective MR films are arranged substantially perpendicular to a medium-facing surface of the sensor, that faces the surface of the magnetic drum. U.S. Pat. No. 5,684,658, though it is in the field of a magnetic head, discloses a high performance dual strip MR sensor element with a plurality of MR films laminated to sandwich an insulation film as well as the MR films in the magnetic sensor disclosed in Japanese patent publication No. 2002-206950A.

The magnetic sensor proposed in Japanese patent publication No. 2002-206950A can narrow the space between the MR elements without reducing the pattern width of each MR element because the plurality of the MR elements are laminated with each other. The magnetic sensor with such structure senses a vertical direction component of the horizontally recorded magnetic field from the magnetic medium. Thus, although it is necessary to have extremely high sensitivity, the proposed magnetic sensor cannot attain such sensitivity because of non-contact structure and using of normal anisotropic MR element structure. Therefore, when the magnetic sensor disclose in Japanese patent publication No. 2002-206950A is used for a magnetic encoder, it is difficult to detect position with a high degree of precision.

### BRIEF SUMMARY OF THE INVENTION

It is therefore an object of the present invention to provide a magnetic sensor for an encoder, whereby precise detection in position and high reliability in the detection can be expected.

According to the present invention, a magnetic sensor for an encoder has a sliding surface and detects magnetic field by keeping the sliding surface in contact with a surface of a magnetic medium to which a magnetic pattern with a predetermined magnetization pitch is recorded. The magnetic sensor includes a plurality of MR elements laminated with each other in a direction parallel to a direction of the magnetization pitch of the magnetic medium. Between two of the MR elements an insulation layer is sandwiched. Each of the MR elements has a plurality of linear sections.

Because the magnetic sensor has the sliding surface kept contact with the surface of the magnetic medium and also each MR element has linear sections or magnetic sensitive portion extending linearly, it is possible to increase sensitivity and output of each MR element. Thus, when used for a magnetic sensor of an encoder, extremely precise detection in position can be obtained to greatly improve reliability in the detection.

It is preferred that the linear sections extend in parallel with the sliding surface.

It is also preferred that the linear sections include a first linear section, and a second linear section positioned farther than the first linear section from the sliding surface.

It is further preferred that each of the MR elements includes two linear strips coupled with each other in U-shape.

It is preferred that the magnetic sensor further includes electrode terminals formed on a surface of the magnetic sensor, which is different from a surface of the sensor faced to the magnetic medium, that is the sliding surface, and electrically connected to the MR elements, respectively. Because the electrode terminals are formed on the surface different from the sliding surface, the magnetic sensor can be extremely downsized and can be fabricated in low cost.

It is preferred that the MR elements are located in a rearward position apart from the sliding surface by 0.1 to 5.0 μm, more preferably by 0.1 to 2.0 μm.

It is also preferred that each of the MR elements is a giant magnetoresistive effect (GMR) element or a tunnel magnetoresistive effect (TMR) element.

Further objects and advantages of the present invention will be apparent from the following description of the preferred embodiments of the invention as illustrated in the accompanying drawings.

### BRIEF DESCRIPTION OF THE SEVERAL VIEWS OF THE DRAWINGS

FIG. 1 shows an oblique view schematically illustrating a configuration of a magnetic encoder as a preferred embodiment according to the present invention;

FIGS. 2a and 2b show an oblique view and an exploded oblique view schematically illustrating a structure of a magnetic sensor assembly of the embodiment shown in FIG. 1;

FIGS. 3a and 3b show an oblique view and an exploded oblique view schematically illustrating a structure of a magnetic sensor shown in FIGS. 2a and 2b;

FIG. 4 shows an equivalent circuit diagram of the magnetic sensor shown in FIGS. 3a and 3b;

FIGS. 5a to 5i show plane views illustrating MR elements and wiring pattern on respective layers of the magnetic sensor shown in FIGS. 3a and 3b;

FIGS. 6a to 6d show views illustrating relationships between magnetization pitches and output signals from the MR element;

FIGS. 7a and 7b show an oblique view and an exploded oblique view schematically illustrating a structure of a magnetic sensor in another embodiment according to the present invention;

FIG. 8 shows an equivalent circuit diagram of the magnetic sensor shown in FIGS. 7a and 7b;

FIGS. 9a and 9b show an oblique view and an exploded oblique view schematically illustrating a structure of a magnetic sensor in a further embodiment according to the present invention;

FIG. 10 shows an equivalent circuit diagram of the magnetic sensor shown in FIGS. 9a and 9b;

FIGS. 11a and 11b show an oblique view and an exploded oblique view schematically illustrating a structure of a magnetic sensor in a reference example;

FIG. 12 shows an equivalent circuit diagram of the magnetic sensor shown in FIGS. 11a and 11b;

FIGS. 13a and 13b show an oblique view and an exploded oblique view schematically illustrating a structure of a magnetic sensor in another reference example; and

FIG. 14 shows an equivalent circuit diagram of the magnetic sensor shown in FIGS. 13a and 13b.

### DETAILED DESCRIPTION OF THE INVENTION

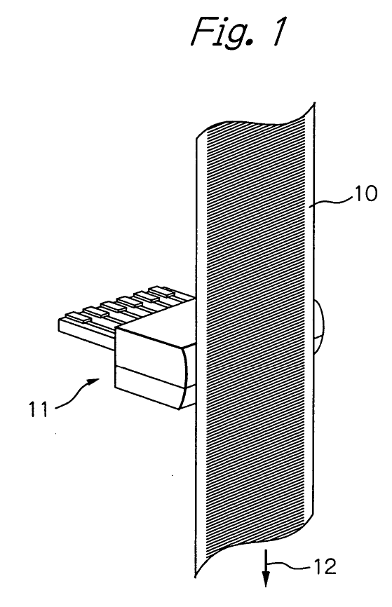

FIG. 1 schematically illustrates a configuration of a magnetic encoder as a preferred embodiment according to the present invention.

In the figure, reference numeral 10 denotes a magnetic medium to which a magnetic pattern with a predetermined magnetization pitch λ is recorded, and 11 denotes a magnetic sensor assembly with a sliding surface faced to and kept in contact with the magnetic medium 10, respectively.

In this embodiment, the magnetic medium 10 is fixed to a surface of an object (not shown) of which position and movement direction are to be detected. During operation, the magnetic sensor assembly 11 is held at rest with keeping in contact with the surface of the magnetic medium 10 like as a magnetic head of a magnetic tape drive apparatus or a flexible disk drive apparatus. The magnetic medium 10 relatively moves with respect to the magnetic sensor assembly 11 in a direction and/or the opposite direction of an arrow 12.

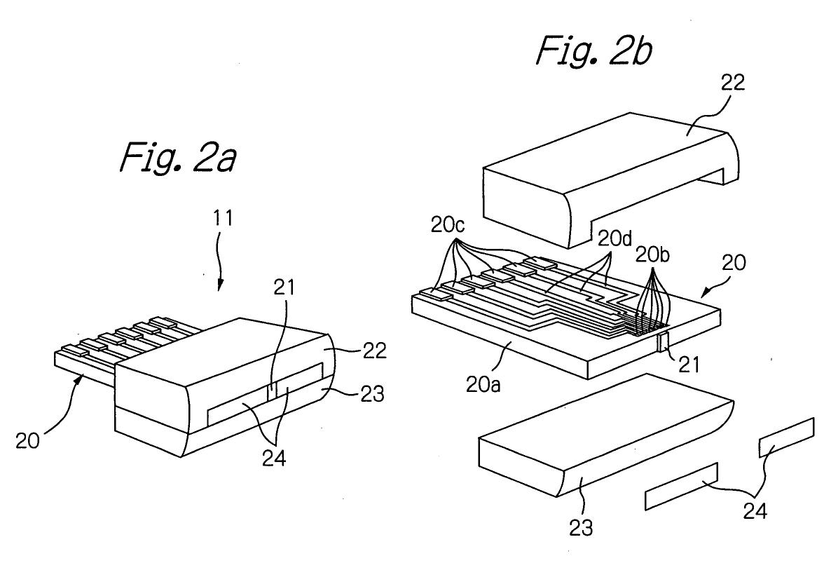

FIGS. 2a and 2b are an oblique view and an exploded oblique view schematically illustrating the structure of this magnetic sensor assembly 11.

As shown in the figure, the magnetic sensor assembly 11 mainly consists of a printed circuit board 20, a sensor chip or magnetic sensor 21 fixed to the center of a front end surface of the printed circuit board 20, an upper housing 22 and a lower housing 23 vertically sandwiching the printed circuit board 20, and coating films 24 covering the front end surface of the printed circuit board 20 except for a section of the magnetic sensor 21.

The printed circuit board 20 is constituted by a substrate 20a made of for example epoxy resin, sensor-connection pads 20b formed on the substrate 20a and wire-bonded to respective electrode terminals of the magnetic sensor 21, external connection pads 20c formed on the substrate 20a, and connection conductors 20d formed on the substrate 20a and electrically connected between the sensor-connection pads 20b and the external connection pads 20c, respectively.

The upper and lower housings 22 and 23 are made of in this embodiment a metal material or a ceramic material.

The coating films 24 are formed by in this embodiment molding a resin.

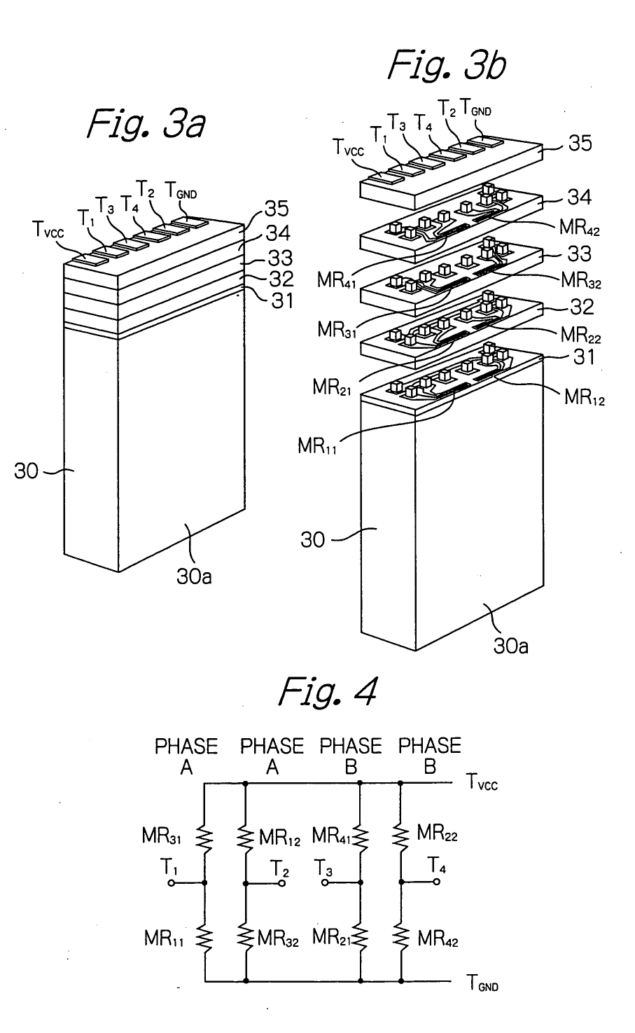

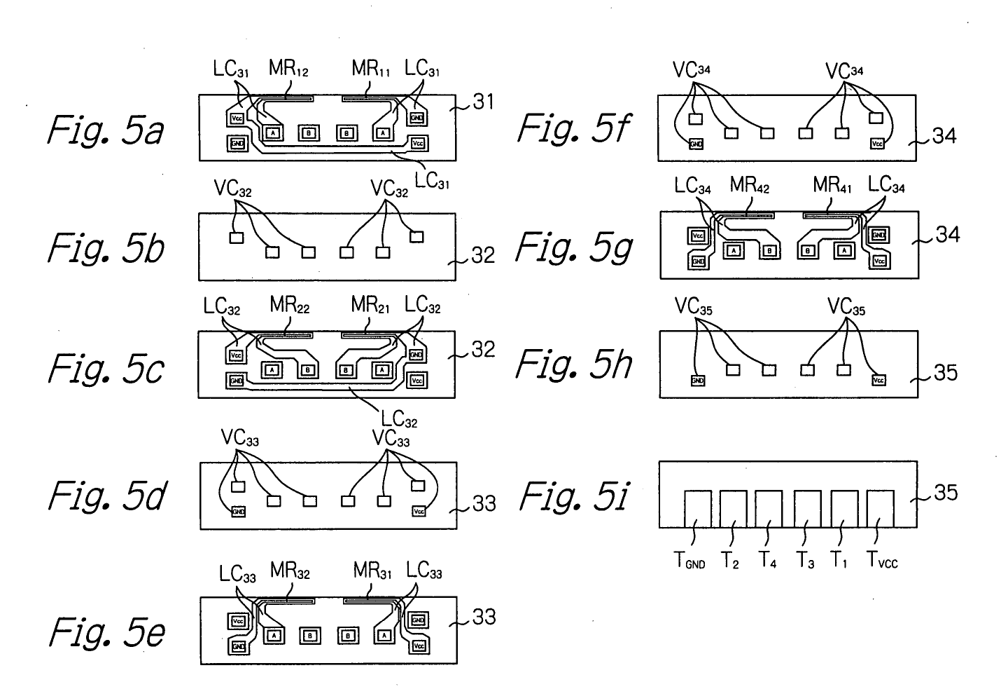

FIGS. 3a and 3b are an oblique view and an exploded oblique view schematically illustrating a structure of the magnetic sensor 21, FIG. 4 is an equivalent circuit diagram of this magnetic sensor 21, and FIGS. 5a to 5i are plane views illustrating the MR elements and wiring pattern on the respective layers of this magnetic sensor 21.

As will be apparent from FIGS. 3a and 3b and FIGS. 5a to 5i, the magnetic sensor 21 in this embodiment has a first insulation layer 31 laminated on an end surface of a sensor substrate or slider 30, which surface is perpendicular to a sliding surface 30a of the slider 30, two MR elements MR₁₁ and MR₁₂ patterned on this first insulation layer 31 and lead conductors LC₃₁ electrically connected these MR elements MR₁₁ and MR₁₂ and patterned on this first insulation layer 31, a second insulation layer 32 laminated thereon, two MR elements MR₂₁ and MR₂₂ patterned on this second insulation layer 32 and lead conductors LC₃₂ electrically connected these MR elements MR₂₁ and MR₂₂ and patterned on this second insulation layer 32, a third insulation layer 33 laminated thereon, two MR elements MR₃₁ and MR₃₂ patterned on this third insulation layer 33 and lead conductors LC₃₃ electrically connected these MR elements MR₃₁ and MR₃₂ and patterned on this third insulation layer 33, a fourth insulation layer 34 laminated thereon, two MR elements MR₄₁ and MR₄₂ patterned on this fourth insulation layer 34 and lead conductors LC₃₄ electrically connected these MR elements MR₄₁ and MR₄₂ and patterned on this fourth insulation layer 34, a fifth insulation layer 35 laminated thereon, electrode terminals or signal retrieval terminals T₁ to T₄, a Vcc terminal T_{VCC} and a ground terminal T_{GND} patterned on this fifth insulation layer 35, and via hole conductors VC₃₂ to VC₃₅ penetrated respectively through the second to fifth insulation layers 32 to 35 and electrically connected between the lead conductors LC₃₁ to LC₃₅ and the signal retrieval terminals T₁ to T₄, the Vcc terminal T_{VCC} and the ground terminal T_{GND}, respectively.

The slider 30 is made of AlTiC (Al₂O₃—TiC) for example, and each of the insulation layers 31 to 35 is made of a nonmagnetic insulating material such as alumina (Al₂O₃) for example. The signal retrieval terminals T₁ to T₄, the Vcc terminal T_{VCC}, the ground terminal T_{GND}, the lead conductors LC₃₁ to LC₃₅, and the via hole conductors VC₃₂ to VC₃₅ are made of an electrical conductor material such as a copper (Cu) for example. Each of the MR elements MR₁₁ to MR₄₂ is configured by an GMR element or TMR element with a multilayered structure.

The MR elements MR₁₁ to MR₄₂ are laminated in four layers with sandwiching each of the second to fourth insulation layers 32 to 34 between two of them, respectively. The laminating direction of these MR elements is the same as the relative movement direction of the magnetic sensor assembly 11 with respect to the magnetic medium 10 (FIG. 1), that is, the pitch direction of the magnetic medium 10. Thus, the MR elements MR₁₁ to MR₄₂ can perform four-phase detection of a vertical direction component of the horizontally recorded magnetic field from the magnetic medium 10. In this embodiment, particularly, the lamination pitch of the MR elements is set to ¼ of the magnetization pitch λ of the magnetic medium 10.

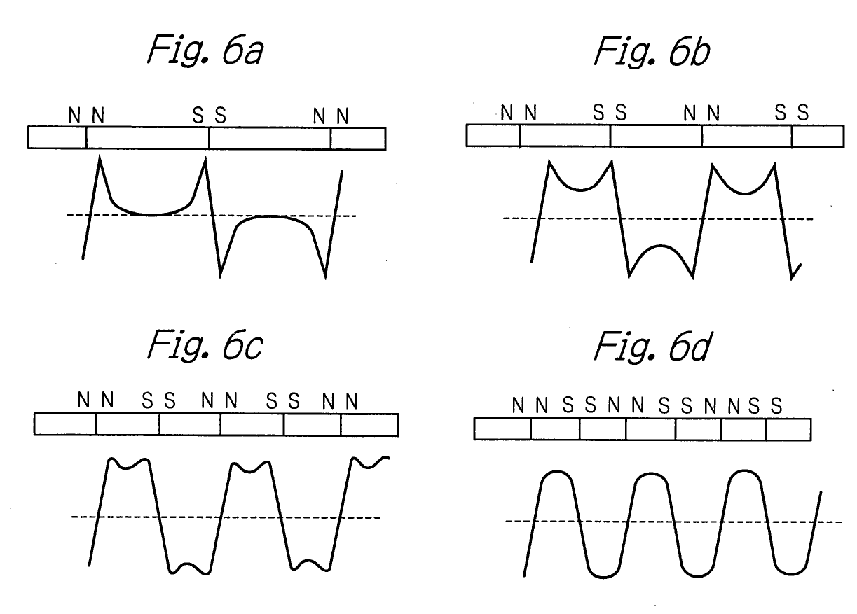

FIGS. 6a to 6d illustrate relationships between the magnetization pitches and output signals from the MR element.

The vertical direction component of the recorded magnetic field becomes the maximum at inversion points of N/S. Thus, as shown in FIGS. 6a to 6c, when the magnetization pitch is wide, an MR output signal obtained by detecting the vertical direction component of this recorded magnetic field has a shape far from the sinusoidal wave shape and its peaks are bowed inward. Contrary to this, as shown in FIG. 6d, when the magnetization pitch is narrow, the MR output signal has a substantially complete sinusoidal wave shape with peaks not deformed. As a result, when the position is detected by zero-cross detection of the MR output signal, a wide margin of the detection can be obtained. Thus, accurate position detection can be expected to extremely improve the reliability in the detected position. Also, no additional signal processing is necessary.

On each layer, the two MR elements are formed near and along the sliding surface 30a. Each MR element has a first linear section extending along or in parallel with the sliding surface 30a and a second linear section extending along or in parallel with the sliding surface 30a but positioned farther than the first linear section from the sliding surface 30a. The first and second linear sections are formed as a linear strip folded back in a U-shape. It is necessary in general to have enough length of about 50 to 200 μm in entire length for the MR element in order to obtain sufficiently large output and high sensitivity. However, if the MR element is extended along the sliding surface 30a without folding, an influence of the azimuth angle may be appeared. In order to avoid this influence, therefore, the MR element is folded back as in this embodiment. The number of folding is not limited to one as in this embodiment but two or more may be adopted. In other words, each MR element may be formed to have three or more linear sections connected with each other by folding.

Each MR element is not exposed to the sliding surface 30a but located in a rearward position slightly apart from the sliding surface 30a by 0.1 to 5.0 μm, desirably by 0.1 to 2.0 μm. On a surface of each MR element faced to the sliding surface 30a, a protection layer made of an insulation material is formed. The minimum limit of this backed distance of the MR element, that is 0.1 μm, corresponds to the minimum admissible thickness of the protection layer for providing the protecting function. The maximum limit thereof, that is 2.0 to 5.0 μm, corresponds to a limit determined by the resolution for detection of the vertical direction component of the magnetic field.

In this embodiment, the MR elements are arranged in four phases with the laminating direction interval of λ/4. Actually, the MR elements are connected to provide a four-phase full bridge configuration as shown in FIG. 4, in which the two MR elements of every two layers having a space of λ/2 are connected in sequence and a double output of λ/4 is derived form its middle point. Namely, the MR elements MR₁₁ and MR₃₁ are connected in sequence and an A-phase signal is derived from its middle point or a terminal T₁ and similarly to this, the MR elements MR₁₂ and MR₃₂ are connected in sequence and an A-phase signal is derived from its middle point or a terminal T₃, and further the MR elements MR₂₁ and MR₄₁ are connected in sequence and a B-phase signal is derived from its middle point or a terminal T₃ and similarly to this, the MR elements MR₂₂ and MR₄₂ are connected in sequence and a B-phase signal is derived from its middle point or a terminal T₄.

As aforementioned, in this embodiment, the full bridge configuration is adopted to obtain the double output. However, in modifications, the outputs from the MR elements with the λ/4 space may be directly output without connecting them in bridge. Furthermore, although in the aforementioned embodiment, two MR elements are formed on each layer, in modifications, a single MR element may be formed on each layer.

Also, the space between the MR elements in the laminating direction is desirably λ/4 as in this embodiment because the highest difference output signal is obtained at that distance. However, in modifications, the space may be any predetermined value other than λ/4 except for λ/2.

The size of the magnetic sensor of this embodiment is such that its one end surface perpendicular to the sliding surface 30a is about 150-300 μm (length of edge perpendicular to the sliding surface)×about 300-600 μm (length of edge parallel to the sliding surface), and the length of each edge along the sliding direction is about 1-2 mm.

According to this embodiment, because the magnetic sensor has the sliding surface kept contact with the surface of the magnetic medium and also each MR element has magnetic sensitive portion with two linear strip sections, it is possible to increase sensitivity and output of each MR element. Thus, when used for a magnetic sensor of an encoder, extremely precise detection in position can be obtained to greatly improve reliability in the detection.

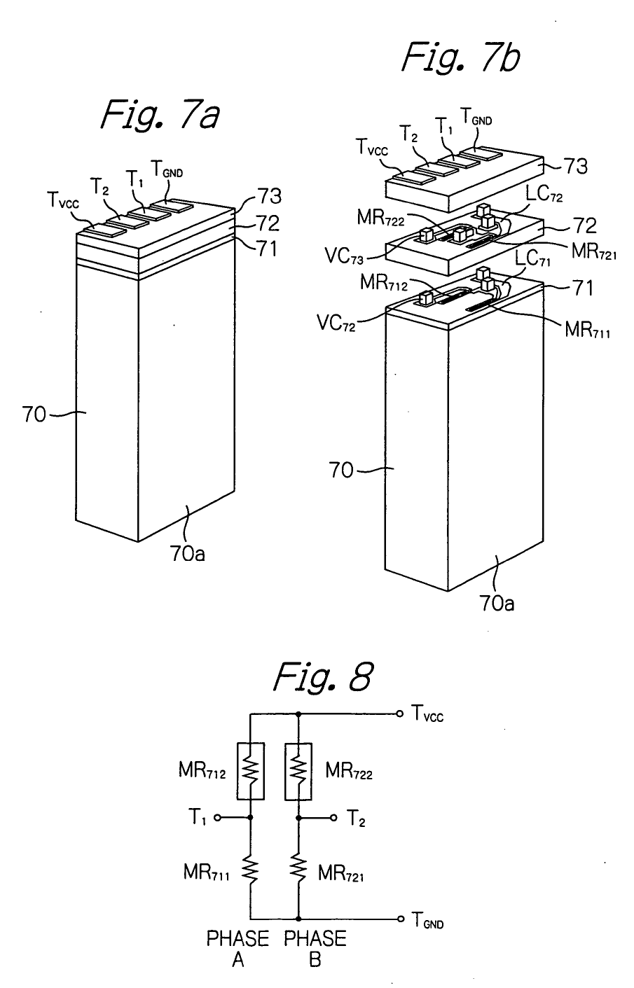

FIGS. 7a and 7b are an oblique view and an exploded oblique view schematically illustrating a structure of a magnetic sensor in another embodiment according to the present invention, and FIG. 8 is an equivalent circuit diagram of the magnetic sensor of this embodiment. Configurations of the magnetic encoder in this embodiment are the same as those in the embodiment of FIG. 1 except for that of the magnetic sensor.

As will be apparent from FIGS. 7a and 7b, the magnetic sensor in this embodiment has a first insulation layer 71 laminated on an end surface of a sensor substrate or slider 70, which is perpendicular to a sliding surface 70a of the slider 70, two MR elements MR₇₁₁ and MR₇₁₂ patterned on this first insulation layer 71 and lead conductors LC₇₁ electrically connected these MR elements MR₇₁₁ and MR₇₁₂ and patterned on this first insulation layer 71, a second insulation layer 72 laminated thereon, two MR elements MR₇₂₁ and MR₇₂₂ patterned on this second insulation layer 72 and lead conductors LC₇₂ electrically connected these MR elements MR₇₂₁ and MR₇₂₂ and patterned on this second insulation layer 72, a third insulation layer 73 laminated thereon, electrode terminals or signal retrieval terminals T₁ and T₂, a Vcc terminal T_{VCC} and a ground terminal T_{GND} patterned on this third insulation layer 73, and via hole conductors VC₇₂ and VC₇₃ penetrated respectively through the second and third insulation layers 72 and 73 and electrically connected between the lead conductors LC₇₁ and LC₇₂ and the signal retrieval terminals T₁ and T₂, the Vcc terminal T_{VCC} and the ground terminal T_{GND}, respectively.

The slider 70 is made of AlTiC (Al₂O₃—TiC) for example, and each of the insulation layers 71 to 73 is made of a nonmagnetic insulating material such as alumina (Al₂O₃) for example. The signal retrieval terminals T₁ and T₂, the Vcc terminal T_{VCC}, the ground terminal T_{GND}, the lead conductors LC₇₁ and LC₇₂, and the via hole conductors VC₇₂ and VC₇₃ are made of an electrical conductor material such as a copper (Cu) for example. Each of the MR elements MR₇₁₁ to MR₇₂₂ is configured by an GMR element or TMR element with a multilayered structure.

The MR elements MR₇₁₁ to MR₇₂₂ are laminated in two layers with sandwiching the second insulation layer 72. The laminating direction of these MR elements is the same as the relative movement direction of the magnetic sensor assembly 11 with respect to the magnetic medium 10 (FIG. 1), that is, the pitch direction of the magnetic medium 10. Thus, the MR elements MR₇₁₁ to MR₇₂₂ can perform two-phase detection of a vertical direction component of the horizontally recorded magnetic field from the magnetic medium 10. In this embodiment, particularly, the lamination pitch of the MR elements is set to ¼ of the magnetization pitch λ of the magnetic medium 10. As will be mentioned later, the MR elements MR₇₁₂ and MR₇₂₂ are used for temperature compensation but not used for magnetic field detection.

On each layer, one MR element for magnetic field detection is formed near and along the sliding surface 70a, and the other MR element for temperature compensation is formed behind it or apart from the sliding surface 70a. Each MR element has a first linear section extending along or in parallel with the sliding surface 70a and a second linear section extending along or in parallel with the sliding surface 70a but positioned farther than the first linear section from the sliding surface 70a. The first and second linear sections are formed as a linear strip folded back in a U-shape. It is necessary in general to have enough length of about 50 to 200 μm in entire length for the MR element in order to obtain sufficiently large output and high sensitivity. However, if the MR element is extended along the sliding surface 70a without folding, an influence of the azimuth angle may be appeared. In order to avoid this influence, therefore, the MR element is folded back as in this embodiment. The number of folding is not limited to one as in this embodiment but two or more may be adopted. In other words, each MR element may be formed to have three or more linear sections connected with each other by folding.

Each MR element is not exposed to the sliding surface 70a but located in a rearward position slightly apart from the sliding surface 70a by 0.1 to 5.0 μm, desirably by 0.1 to 2.0 μm. On a surface of each MR element faced to the sliding surface 70a, a protection layer made of an insulation material is formed. The minimum limit of this backed distance of the MR element, that is 0.1 μm, corresponds to the minimum admissible thickness of the protection layer for providing the protecting function. The maximum limit thereof, that is 2.0 to 5.0 μm, corresponds to a limit determined by the resolution for detection of the vertical direction component of the magnetic field.

In this embodiment, the MR elements are arranged in two phases with the laminating direction interval of λ/4. Actually, the MR elements are connected to provide a two-phase half bridge configuration as shown in FIG. 8, in which the two MR elements are connected in sequence and an output is derived form its middle point. Namely, the MR elements MR₇₁₁ and MR₇₁₂ are connected in sequence and an A-phase signal is derived from its middle point or a terminal T₁, and the MR elements MR₇₂₁ and MR₇₂₂ are connected in sequence and an B-phase signal is derived from its middle point or a terminal T₂.

In this embodiment, the half bridge configuration is adopted. However, in modifications, the outputs from the MR elements with the λ/4 space may be directly output without connecting them in bridge.

Also, the space between the MR elements in the laminating direction is desirably λ/4 as in this embodiment because the highest difference output signal is obtained at that distance. However, in modifications, the space may be any predetermined value other than λ/4 except for λ/2.

The size of the magnetic sensor of this embodiment is substantially the same as that in the embodiment of FIG. 1.

According to this embodiment, because the magnetic sensor has the sliding surface kept contact with the surface of the magnetic medium and also each MR element has magnetic sensitive portion with two linear strip sections, it is possible to increase sensitivity and output of each MR element. Thus, when used for a magnetic sensor of an encoder, extremely precise detection in position can be obtained to greatly improve reliability in the detection.

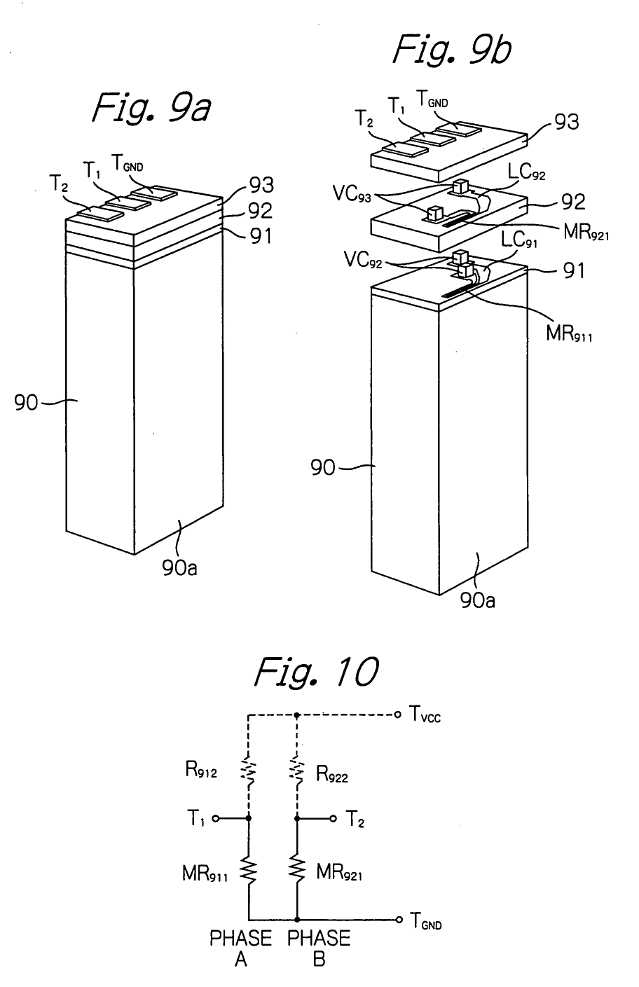

FIGS. 9a and 9b are an oblique view and an exploded oblique view schematically illustrating a structure of a magnetic sensor in another embodiment according to the present invention, and FIG. 10 is an equivalent circuit diagram of the magnetic sensor of this embodiment. Configurations of the magnetic encoder in this embodiment are the same as those in the embodiment of FIG. 1 except for that of the magnetic sensor.

As will be apparent from FIGS. 9a and 9b, the magnetic sensor in this embodiment has a first insulation layer 91 laminated on an end surface of a sensor substrate or slider 90, which is perpendicular to a sliding surface 90a of the slider 90, a single MR element MR₉₁₁ patterned on this first insulation layer 91 and lead conductors LC₉₁ electrically connected this MR element MR₉₁₁ and patterned on this first insulation layer 91, a second insulation layer 92 laminated thereon, a single MR element MR₉₂₁ patterned on this second insulation layer 92 and lead conductors LC₉₂ electrically connected this MR element MR₉₂₁ and patterned on this second insulation layer 92, a third insulation layer 93 laminated thereon, electrode terminals or signal retrieval terminals T₁ and T₂ and a ground terminal T_{GND} patterned on this third insulation layer 93, and via hole conductors VC₉₂ and VC₉₃ penetrated respectively through the second and third insulation layers 92 and 93 and electrically connected between the lead conductors LC₉₁ and LC₉₂ and the signal retrieval terminals T₁ and T₂, and the ground terminal T_{GND}, respectively.

The slider 90 is made of AlTiC (Al₂O₃—TiC) for example, and each of the insulation layers 91 to 93 is made of a nonmagnetic insulating material such as alumina (Al₂O₃) for example. The signal retrieval terminals T₁ and T₂, the ground terminal T_{GND}, the lead conductors LC₉₁ and LC₉₂, and the via hole conductors VC₉₂ and VC₉₃ are made of an electrical conductor material such as a copper (Cu) for example. Each of the MR elements MR₉₁₁ and MR₉₂₁ is configured by an GMR element or TMR element with a multilayered structure.

The MR elements MR₉₁₁ and MR₉₂₁ are laminated in two layers with sandwiching the second insulation layer 92. The laminating direction of these MR elements is the same as the relative movement direction of the magnetic sensor assembly 11 with respect to the magnetic medium 10 (FIG. 1), that is, the pitch direction of the magnetic medium 10. Thus, the MR elements MR₉₁₁ and MR₉₂₁ can perform two-phase detection of a vertical direction component of the horizontally recorded magnetic field from the magnetic medium 10. In this embodiment, particularly, the lamination pitch of the MR elements is set to ¼ of the magnetization pitch λ of the magnetic medium 10.

On each layer, the single MR element for magnetic field detection is formed near and along the sliding surface 90a. Each MR element has a first linear section extending along or in parallel with the sliding surface 90a and a second linear section extending along or in parallel with the sliding surface 90a but positioned farther than the first linear section from the sliding surface 90a. The first and second linear sections are formed as a linear strip folded back in a U-shape. It is necessary in general to have enough length of about 50 to 200 μm in entire length for the MR element in order to obtain sufficiently large output and high sensitivity. However, if the MR element is extended along the sliding surface 90a without folding, an influence of the azimuth angle may be appeared. In order to avoid this influence, therefore, the MR element is folded back as in this embodiment. The number of folding is not limited to one as in this embodiment but two or more may be adopted. In other words, each MR element may be formed to have three or more linear sections connected with each other by folding.

Each MR element is not exposed to the sliding surface 90a but located in a rearward position slightly apart from the sliding surface 90a by 0.1 to 5.0 μm, desirably by 0.1 to 2.0 μm. On a surface of each MR element faced to the sliding surface 90a, a protection layer made of an insulation material is formed. The minimum limit of this backed distance of the MR element, that is 0.1 μm, corresponds to the minimum admissible thickness of the protection layer for providing the protecting function. The maximum limit thereof, that is 2.0 to 5.0 μm, corresponds to a limit determined by the resolution for detection of the vertical direction component of the magnetic field.

In this embodiment, the MR elements are arranged in two phases with the laminating direction interval of λ/4. Actually, the MR element in each layer and an external resistor for temperature compensation are connected to provide a two-phase half bridge configuration as shown in FIG. 10, in which the MR element and the resistor are connected in sequence and an output is derived form its middle point. Namely, the MR element MR₉₁₁ and the external resistor R₉₁₂ indicated by a dotted line are connected in sequence and an A-phase signal is derived from its middle point or a terminal T₁, and the MR element MR₉₂₁ and the external resistor R₉₂₂ indicated by a dotted line are connected in sequence and an B-phase signal is derived from its middle point or a terminal T₂. Instead of the external resistors, constant current sources may be connected, respectively.

In this embodiment, the half bridge configuration is adopted. However, in modifications, the outputs from the MR elements with the λ/4 space may be directly output without connecting them in bridge.

Also, the space between the MR elements in the laminating direction is desirably λ/4 as in this embodiment because the highest difference output signal is obtained at that distance. However, in modifications, the space may be any predetermined value other than λ/4 except for λ/2.

The size of the magnetic sensor of this embodiment is substantially the same as that in the embodiment of FIG. 1.

According to this embodiment, because the magnetic sensor has the sliding surface kept contact with the surface of the magnetic medium and also each MR element has magnetic sensitive portion with two linear strip sections, it is possible to increase sensitivity and output of each MR element. Thus, when used for a magnetic sensor of an encoder, extremely precise detection in position can be obtained to greatly improve reliability in the detection.

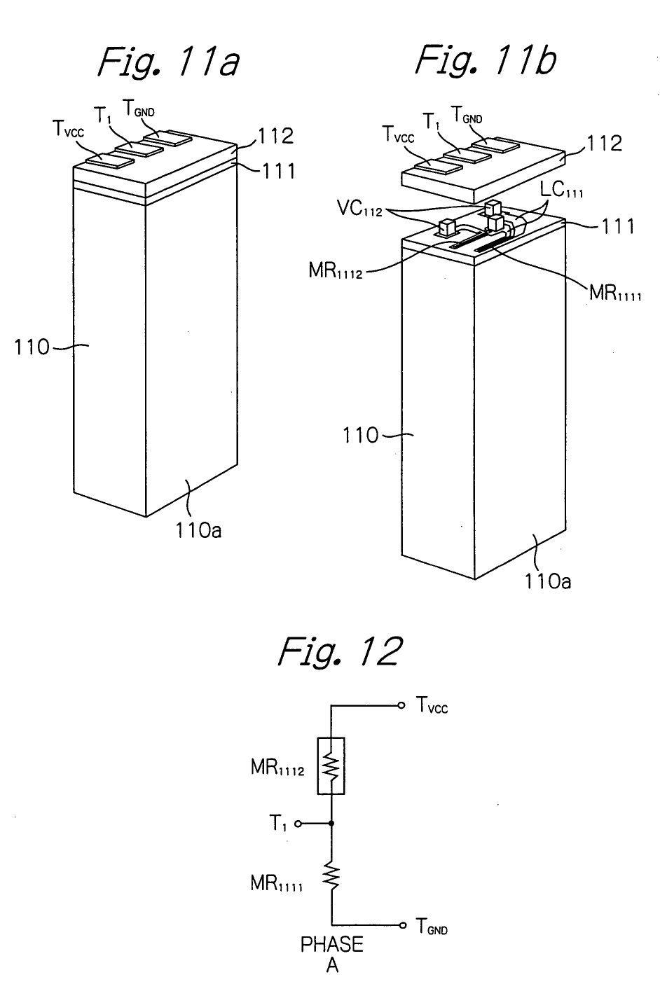

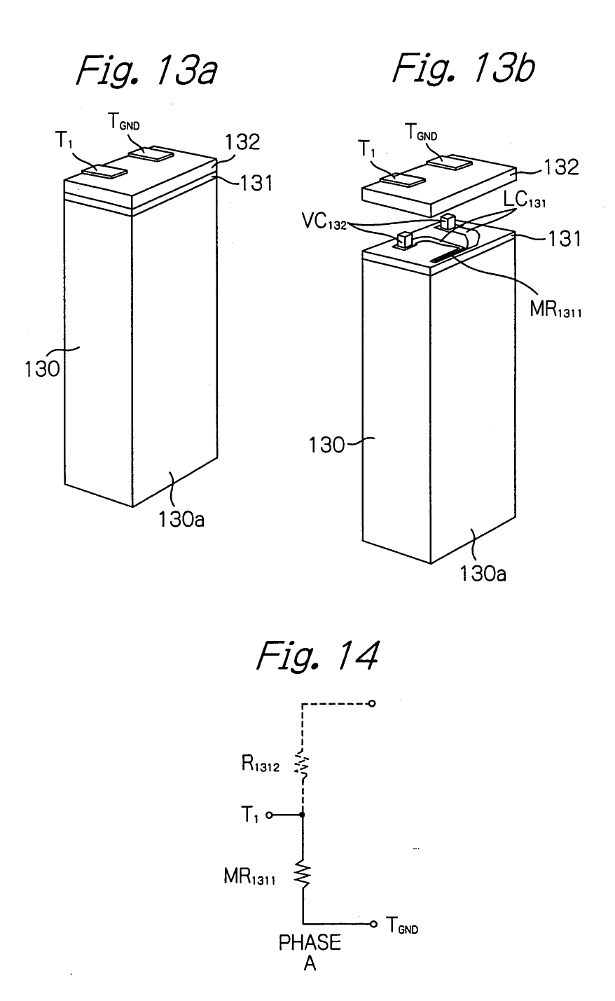

FIGS. 11a and 11b are an oblique view and an exploded oblique view schematically illustrating a structure of a magnetic sensor in a reference example that is not included within the present invention, and FIG. 12 is an equivalent circuit diagram of the magnetic sensor of this reference example. Configurations of the magnetic encoder in this reference example are the same as those in the embodiment of FIG. 1 except for that of the magnetic sensor.

As will be apparent from FIGS. 11a and 11b, the magnetic sensor in this reference example has a first insulation layer 111 laminated on an end surface of a sensor substrate or slider 110, which is perpendicular to a sliding surface 110a of the slider 110, two MR elements MR₁₁₁₁ and MR₁₁₁₂ patterned on this first insulation layer 111 and lead conductors LC₁₁₁ electrically connected these MR elements MR₁₁₁₁ and MR₁₁₁₂ and patterned on this first insulation layer 111, a second insulation layer 112 laminated thereon, an electrode terminal or signal retrieval terminal T₁, a Vcc terminal T_{VCC} and a ground terminal T_{GND} patterned on this second insulation layer 112, and via hole conductors VC₁₁₂ penetrated through the second insulation layer 112 and electrically connected between the lead conductors LC₁₁₁ and the signal retrieval terminal T₁, the Vcc terminal T_{VCC} and the ground terminal T_{GND}, respectively.

The slider 110 is made of AlTiC (Al₂O₃—TiC) for example, and each of the insulation layers 111 and 112 is made of a nonmagnetic insulating material such as alumina (Al₂O₃) for example. The signal retrieval terminal T₁, the Vcc terminal T_{VCC}, the ground terminal T_{GND}, the lead conductors LC₁₁₁, and the via hole conductors VC₁₁₂ are made of an electrical conductor material such as a copper (Cu) for example. Each of the MR elements MR₁₁₁₁ and MR₁₁₁₂ is configured by an GMR element or TMR element with a multilayered structure.

The MR elements MR₁₁₁₁ and MR₁₁₁₂ are laminated as a single layer on the first insulation layer 111. The laminating direction of the MR elements is the same as the relative movement direction of the magnetic sensor assembly 11 with respect to the magnetic medium 10 (FIG. 1), that is, the pitch direction of the magnetic medium 10. Thus, the MR element MR₁₁₁₁₁ can perform single-phase detection of a vertical direction component of the horizontally recorded magnetic field from the magnetic medium 10. As will be mentioned later, the MR element MR₁₁₁₂ is used for temperature compensation but not used for magnetic field detection.

On the first insulation layer 111, one MR element MR₁₁₁₁ for magnetic field detection is formed near and along the sliding surface 110a, and the other MR element MR₁₁₁₂ for temperature compensation is formed behind it or apart from the sliding surface 110a. Each MR element has a first linear section extending along or in parallel with the sliding surface 110a and a second linear section extending along or in parallel with the sliding surface 110a but positioned farther than the first linear section from the sliding surface 110a. The first and second linear sections are formed as a linear strip folded back in a U-shape. It is necessary in general to have enough length of about 50 to 200 μm in entire length for the MR element in order to obtain sufficiently large output and high sensitivity. However, if the MR element is extended along the sliding surface 110a without folding, an influence of the azimuth angle may be appeared. In order to avoid this influence, therefore, the MR element is folded back as in this embodiment. The number of folding is not limited to one as in this embodiment but two or more may be adopted. In other words, each MR element may be formed to have three or more linear sections connected with each other by folding.

The MR element for magnetic field detection is not exposed to the sliding surface 110a but located in a rearward position slightly apart from the sliding surface 110a by 0.1 to 5.0 μm, desirably by 0.1 to 2.0 μm. On a surface of the MR element faced to the sliding surface 110a, a protection layer made of an insulation material is formed. The minimum limit of this backed distance of the MR element, that is 0.1 μm, corresponds to the minimum admissible thickness of the protection layer for providing the protecting function. The maximum limit thereof, that is 2.0 to 5.0 μm, corresponds to a limit determined by the resolution for detection of the vertical direction component of the magnetic field.

In this reference example, the MR elements are connected to provide a single-phase half bridge configuration as shown in FIG. 12, in which the two MR elements are connected in sequence and an output is derived form its middle point. Namely, the MR elements MR₁₁₁₁ and MR₁₁₁₂ are connected in sequence and only an A-phase signal is derived from its middle point or a terminal T₁.

As aforementioned, in this reference example, the half bridge configuration is adopted. However, in modifications, the outputs from the MR elements may be directly output without connecting them in bridge.

The size of the magnetic sensor of this reference example is substantially the same as that in the embodiment of FIG. 1.

FIGS. 13a and 13b are an oblique view and an exploded oblique view schematically illustrating a structure of a magnetic sensor in another reference example that is not included within the present invention, and FIG. 14 is an equivalent circuit diagram of the magnetic sensor of this reference example. Configurations of the magnetic encoder in this reference example are the same as those in the embodiment of FIG. 1 except for that of the magnetic sensor.

As will be apparent from FIGS. 13a and 13b, the magnetic sensor in this reference example has a first insulation layer 131 laminated on an end surface of a sensor substrate or slider 130, which is perpendicular to a sliding surface 130a of the slider 130, an single MR element MR₁₃₁₁ patterned on this first insulation layer 131 and lead conductors LC₁₃₁ electrically connected the MR element MR₁₃₁₁ and patterned on this first insulation layer 131, a second insulation layer 132 laminated thereon, an electrode terminal or signal retrieval terminal T₁, a Vcc terminal T_{VCC} and a ground terminal T_{GND} patterned on this second insulation layer 132, and via hole conductors VC₁₃₂ penetrated through the second insulation layer 132 and electrically connected between the lead conductors LC₁₃, and the signal retrieval terminal T₁, the Vcc terminal T_{VCC} and the ground terminal T_{GND}, respectively.

The slider 130 is made of AlTiC (Al₂O₃—TiC) for example, and each of the insulation layers 131 and 132 is made of a nonmagnetic insulating material such as alumina (Al₂O₃) for example. The signal retrieval terminal T₁, the Vcc terminal T_{VCC}, the ground terminal T_{GND}, the lead conductors LC₁₃₁, and the via hole conductors VC₁₃₂ are made of an electrical conductor material such as a copper (Cu) for example. The MR element MR₁₃₁₁ is configured by an GMR element or TMR element with a multilayered structure.

The MR element MR₁₃₁₁ is laminated as a single layer on the first insulation layer 131. The laminating direction of the MR element is the same as the relative movement direction of the magnetic sensor assembly 11 with respect to the magnetic medium 10 (FIG. 1), that is, the pitch direction of the magnetic medium 10. Thus, the MR element MR₁₃₁₁₁ can perform single-phase detection of a vertical direction component of the horizontally recorded magnetic field from the magnetic medium 10.

On the first insulation layer 131, the single MR element MR₁₃₁₁ is formed near and along the sliding surface 130a. This MR element has a first linear section extending along or in parallel with the sliding surface 130a and a second linear section extending along or in parallel with the sliding surface 130a but positioned farther than the first linear section from the sliding surface 130a. The first and second linear sections are formed as a linear strip folded back in a U-shape. It is necessary in general to have enough length of about 50 to 200 μm in entire length for the MR element in order to obtain sufficiently large output and high sensitivity. However, if the MR element is extended along the sliding surface 130a without folding, an influence of the azimuth angle may be appeared. In order to avoid this influence, therefore, the MR element is folded back as in this embodiment. The number of folding is not limited to one as in this embodiment but two or more may be adopted. In other words, each MR element may be formed to have three or more linear sections connected with each other by folding.

The MR element MR₁₃₁₁ is not exposed to the sliding surface 130a but located in a rearward position slightly apart from the sliding surface 130a by 0.1 to 5.0 μm, desirably by 0.1 to 2.0 μm. On a surface of the MR element faced to the sliding surface 130a, a protection layer made of an insulation material is formed. The minimum limit of this backed distance of the MR element, that is 0.1 μm, corresponds to the minimum admissible thickness of the protection layer for providing the protecting function. The maximum limit thereof, that is 2.0 to 5.0 μm, corresponds to a limit determined by the resolution for detection of the vertical direction component of the magnetic field.

In this reference example, the MR element and an external resistor for temperature compensation are connected to provide a single-phase half bridge configuration as shown in FIG. 14, in which the MR element and the resistor are connected in sequence and an output is derived form its middle point. Namely, the MR element MR₁₃₁₁ and the external resistor R₁₃₁₂ indicated by a dotted line are connected in sequence and only an A-phase signal is derived from its middle point or a terminal T₁. Instead of the external resistor, a constant current source may be connected.

As aforementioned, in this reference example, the half bridge configuration is adopted. However, in modifications, the outputs from the MR element may be directly output without connecting it in bridge.

The size of the magnetic sensor of this reference example is substantially the same as that in the embodiment of FIG. 1.

In the aforementioned embodiments not in the reference examples, the MR elements are laminated in multi-layers such as four layers for four-phase or two layers for two-phase. However, the number of the laminated layers of the MR elements in the magnetic sensor according to the present invention is not limited to these values but may be six, eight or other value. Also, in the aforementioned embodiments, the lamination pitch of the MR elements is set to ¼ of the magnetization pitch λ of the magnetic medium 10. However, it is apparent that the lamination pitch may be represented by a more typical equation of (2n+1)λ/4, where n is a natural number.

Many widely different embodiments of the present invention may be constructed without departing from the spirit and scope of the present invention. It should be understood that the present invention is not limited to the specific embodiments described in the specification, except as defined in the appended claims.

1. A magnetic sensor for an encoder, having a sliding surface and detecting magnetic field by keeping said sliding surface in contact with a surface of a magnetic medium to which a magnetic pattern with a predetermined magnetization pitch is recorded, said magnetic sensor comprising:
a plurality of magnetoresistive effect elements laminated with each other in a direction parallel to a direction of the magnetization pitch of said magnetic medium, between two of said magnetoresistive effect elements an insulation layer being sandwiched, each of said magnetoresistive effect elements having a plurality of linear sections.

2. The magnetic sensor as claimed in claim 1, wherein said linear sections extend in parallel with said sliding surface.

3. The magnetic sensor as claimed in claim 1, wherein said linear sections include a first linear section, and a second linear section positioned farther than said first linear section from said sliding surface.

4. The magnetic sensor as claimed in claim 1, wherein each of said magnetoresistive effect elements includes two linear strips coupled with each other in U-shape.

5. The magnetic sensor as claimed in claim 1, wherein said magnetic sensor further comprises electrode terminals formed on a surface of said magnetic sensor, which is different from a surface of said sensor faced to said magnetic medium, and electrically connected to said magnetoresistive effect elements, respectively.

6. The magnetic sensor as claimed in claim 1, wherein said magnetoresistive effect elements are located in a rearward position apart from said sliding surface by 0.1 to 5.0 μm.

7. The magnetic sensor as claimed in claim 6, wherein said magnetoresistive effect elements are located in a rearward position apart from said sliding surface by 0.1 to 2.0 μm.

8. The magnetic sensor as claimed in claim 1, wherein each of said magnetoresistive effect elements is a giant magnetoresistive effect element or a tunnel magnetoresistive effect element.
